(19) United States
(12) Patent Application Publication
(10) Pub. No.: US 2005/0097804 A1
(43) Pub. Date: May 12, 2005

(54) Guide ring for a fishing rod

(76) Inventor: Tsung-Seng Lee, Tainan City (TW)

Correspondence Address: BIRCH STEWART KOLASCH & BIRCH, PO BOX 747, FALLS CHURCH, VA, 22040-0747, US

(21) Appl. No.: 10/701,608

(22) Filed: Nov. 6, 2003

(51) Int. Cl. A01K 87/04

(52) U.S. Cl. 43/24

(57) ABSTRACT

A guide ring for a fishing rod includes a circular ring and a fixing frame. The fixing frame includes two symmetrical conical inclined portions, a connection portion and a receiving hole. The conical inclined portions are downward expanded from the vicinity of bottom of the circular ring. The connection portion is disposed between the two symmetrical conical inclined portions. The receiving hole is disposed in the connection portion and provided with different kinds of labels. The connection portion increases the strength of the whole structure. The guide ring can be directly recognized by eye, and the shape of the fixing frame is obvious.

### FIELD OF THE INVENTION

The present invention relates to a guide ring for a fishing rod, and more particularly to a guide ring for a fishing rod which includes a connection portion being more beautiful and changed and increases the strength of the whole structure

### BACKGROUND OF THE INVENTION

Generally, conventional guide ring for a fishing rod is mainly designed how to improve the shape and structure of the guide ring, and therefore the modeling and style of the guide ring are nearly not changed. The styles of the guide ring manufactured by different companies are gradually similar and uniform. For user who is looking for modem fashion, the above-mentioned guide ring cannot meet their requirement of fashion. The whole structure of a fixing frame of the guide ring for the fishing rod is not strong enough and further has a serious disadvantage.

Accordingly, there exists a need for a guide ring for a fishing rod to solve the above-mentioned problems and disadvantages.

### SUMMARY OF THE INVENTION

It is an object of the present invention to provide a guide ring for a fishing rod which includes a connection portion being more beautiful and changed and increases the strength of the whole structure.

It is another object of the present invention to provide a guide ring for a fishing rod including the receiving hole provided with different kinds of labels, such as labels of a figure, a pattern, numerals and fluorescent light, if necessary. The shape of the guide ring for the fishing rod is obvious. Further, when a fisher go fishing at night, the guide ring for the fishing rod providing with the label of fluorescent light is especially obvious so as to produce a unique benefit.

In order to achieve the foregoing objects, the present invention provides a guide ring for a fishing rod including a circular ring and a fixing frame. The fixing frame includes two symmetrical conical inclined portions, a connection portion and a receiving hole. The conical inclined portions are downward expanded from the vicinity of bottom of the circular ring. The connection portion is disposed between the two symmetrical conical inclined portions. The receiving hole is disposed in the connection portion and provided with different kinds of labels.

The fixing frame according to the present invention the present invention includes a connection portion increasing the strength of the whole structure and having beauty and uniqueness, so the guide ring can meet user's requirement of fashion. The fixing frame according to the present invention the present invention includes the receiving hole provided with different kinds of labels, such as labels of a figure, a pattern, numerals and fluorescent light, if necessary.

The shape of the guide ring for the fishing rod is obvious. Further, when a fisher go fishing at night, the guide ring for the fishing rod providing with the label of fluorescent light is especially obvious so as to produce a unique benefit.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of a guide ring for a fishing rod according to the first embodiment of the present invention.

FIG. 2 is a front elevational view of a guide ring for a fishing rod according to the first embodiment of the present invention.

FIG. 3 is a front elevational view of a guide ring provided with a label for a fishing rod according to the first embodiment of the present invention.

FIG. 4 is a perspective view of a guide ring for a fishing rod according to the second embodiment of the present invention.

FIG. 5 is a perspective view of a guide ring for a fishing rod according to the third embodiment of the present invention.

FIG. 6 is a perspective view of a guide ring for a fishing rod according to the fourth embodiment of the present invention.

FIG. 7 is a perspective view of a guide ring for a fishing rod according to the fifth embodiment of the present invention.

FIG. 8 is a perspective view of a guide ring for a fishing rod according to the sixth embodiment of the present invention.

FIG. 9 is a perspective view of a guide ring for a fishing rod according to the seventh embodiment of the present invention.

FIG. 10 is a perspective view of a guide ring for a fishing rod according to the eighth embodiment of the present invention.

FIG. 11 is a perspective view of a guide ring for a fishing rod according to the ninth embodiment of the present invention.

### DESCRIPTION OF THE PREFERRED EMBODIMENTS

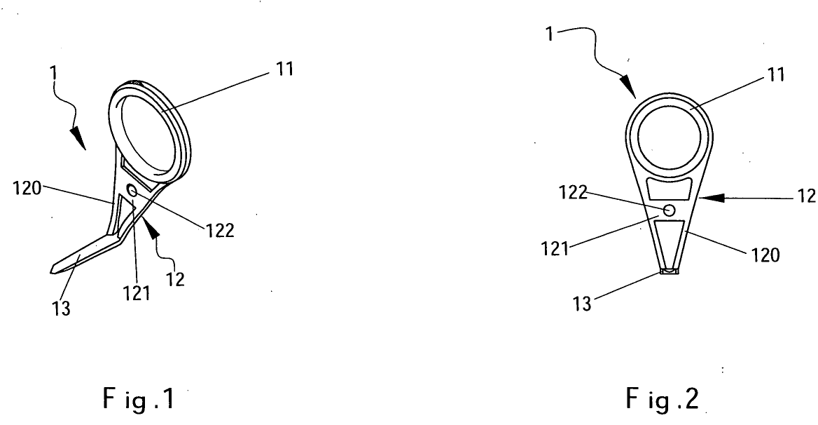

Referring to FIGS. 1 and 2, they depict a guide ring 1 for a fishing rod according to the first embodiment of the present invention. The guide ring 1 includes a circular ring 11, a fixing frame 12 and a fixing leg 13.

The circular ring 11 is passed through by a fishing line and disposed on a main body of the guide ring 1.

The fixing frame 12 is disposed on a throat of the guide ring and is formed by two symmetrical conical inclined portions 120 which are downward expanded from the vicinity of bottom of the circular ring 11. A connection portion 121 is disposed between the two symmetrical conical inclined portions 120. A receiving hole 122 is disposed in the connection portion 121 and provided with an obvious label at a suitable position. Simultaneously, the receiving hole 122 is provided with different kinds of labels 123, such as labels of a figure, a pattern, numerals and fluorescent light, if necessary.

The fixing leg 13 is formed at the end of the two symmetrical conical inclined portions 120 and generally fixed at the suitable position of the fishing rod by entwining fishing lines around the fishing rod.

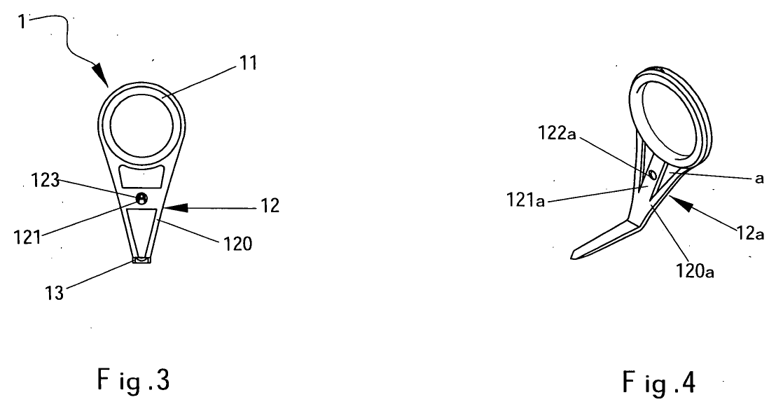

Referring to FIG. 3, it depicts a guide ring 1 for a fishing rod having an obvious label. As described above, a connection portion 121 is disposed between the two symmetrical conical inclined portions 120. A receiving hole 122 is disposed in the connection portion 121 and provided with an obvious label at a suitable position. Simultaneously, the receiving hole 122 is provided with different kinds of labels 123, such as labels of a figure, a pattern, numerals and fluorescent light, if necessary. For above reason, the shape of the guide ring 1 for the fishing rod is obvious. Further, when a fisher go fishing at night, the guide ring for the fishing rod providing with the label of fluorescent light is especially obvious so as to produce a unique benefit.

Referring to FIG. 4, it depicts a guide ring for a fishing rod according to the second embodiment of the present invention. The guide ring for a fishing rod according to the second embodiment is similar to the guide ring for the fishing rod according to the first embodiment. The different between the second and first embodiments is as follows: A longitudinal connection portion 121a is disposed in a space a defined by two symmetrical conical inclined portions 120a. A receiving hole 122a is disposed in the longitudinal connection portion 121a. The receiving hole 122a is provided with different kinds of labels, such as labels of a figure, a pattern, numerals and fluorescent light, if necessary.

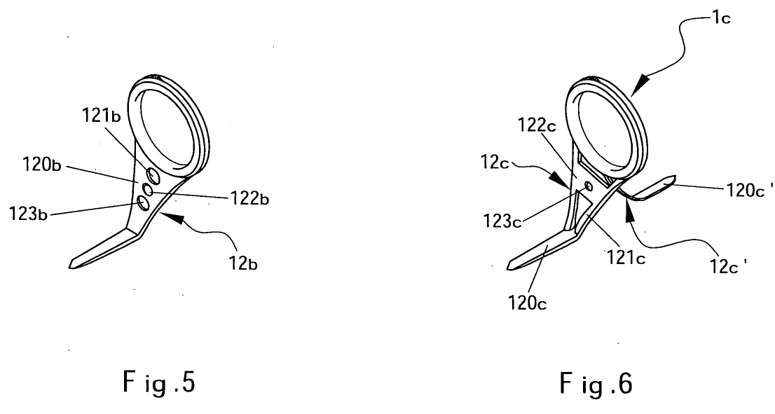

Referring to FIG. 5, it depicts a guide ring for a fishing rod according to the third embodiment of the present invention. The guide ring for a fishing rod according to the third embodiment is similar to the guide ring for the fishing rod according to the first embodiment. The different between the third and first embodiments is as follows: A plurality of receiving hole 121b, 122b and 123b are disposed between two symmetrical conical inclined portions 120b. The receiving hole 122b is provided with different kinds of labels, such as labels of a figure, a pattern, numerals and fluorescent light, if necessary.

Referring to FIG. 6, it depicts a guide ring for a fishing rod according to the fourth embodiment of the present invention. The guide ring for a fishing rod according to the fourth embodiment is similar to the guide ring for the fishing rod according to the first embodiment. The different between the fourth and first embodiments is as follows: The guide ring 1c includes a fixing frame 12c and a fixing frame 12c′ corresponding to the fixing frame 12c in opposite direction. The fixing legs 120c, 120c′ are formed and respectively expanded from the end of the fixing frames 12c, 12c′. The fixing frame 12c is formed by two symmetrical conical inclined portions 121c which are downward expanded from the vicinity of bottom of a circular ring of the guide ring 1c, so is the fixing frame 12c′. The connection portion 122c is disposed between any two symmetrical conical inclined portions 122c of the two fixing frames 12c, 12c′. A receiving hole 123c is disposed in the connection portion 122c. The receiving hole 123c is provided with different kinds of labels, such as labels of a figure, a pattern, numerals and fluorescent light, if necessary.

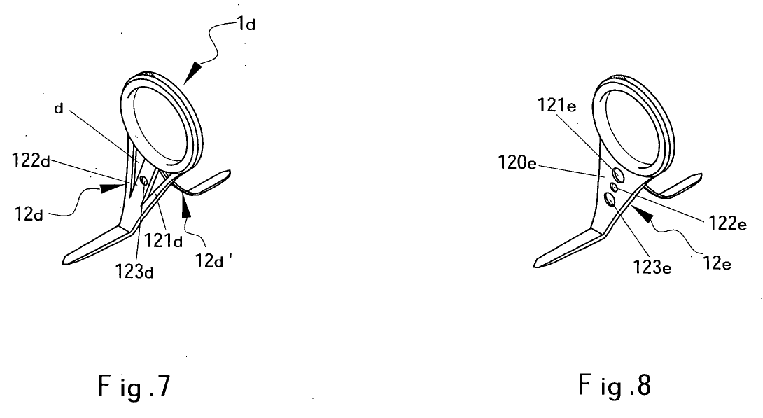

Referring to FIG. 7, it depicts a guide ring for a fishing rod according to the fifth embodiment of the present invention. The guide ring for a fishing rod according to the fifth embodiment is similar to the guide ring for the fishing rod according to the fourth embodiment. The different between the fifth and fourth embodiments is as follows: The guide ring Id includes a fixing frame 12d and a fixing frame 12d′ corresponding to the fixing frame 12d in opposite direction. The fixing frame 12d is formed by two symmetrical conical inclined portions 121d which are downward expanded from the vicinity of bottom of a circular ring of the guide ring Id, so is the fixing frame 12d′. The longitudinal connection portion 122d is disposed in a space d defined by two symmetrical conical inclined portions 121d. A receiving hole 123d is disposed in the longitudinal connection portion 122d. The receiving hole 123d is provided with different kinds of labels, such as labels of a figure, a pattern, numerals and fluorescent light, if necessary.

Referring to FIG. 8, it depicts a guide ring for a fishing rod according to the sixth embodiment of the present invention. The guide ring for a fishing rod according to the sixth embodiment is similar to the guide ring for the fishing rod according to the fourth embodiment. The different between the sixth and fourth embodiments is as follows: The fixing frame 12e is formed by two symmetrical conical inclined portions 120e. A plurality of receiving hole 121e, 122e and 123e are disposed between two symmetrical conical inclined portions 120e. The receiving hole 122e is provided with different kinds of labels, such as labels of a figure, a pattern, numerals and fluorescent light, if necessary.

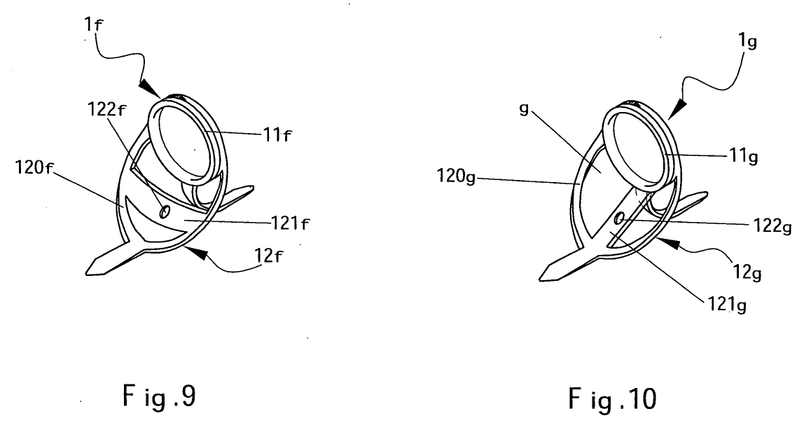

Referring to FIG. 9, it depicts a guide ring 1f for a fishing rod according to the seventh embodiment of the present invention. The guide ring 1f for a fishing rod according to the seventh embodiment is similar to the guide ring for the fishing rod according to the first embodiment. The different between the seventh and first embodiments is as follows: The fixing frame 12f is formed by two symmetrical conical inclined portions 120f which are downward and slightly outward expanded from two sides of the ring 11f of the guide ring 1f. A connection portion 121f is disposed between two symmetrical conical inclined portions 120f. A receiving hole 122f is disposed in the longitudinal connection portion 121f. The receiving hole 122f is provided with different kinds of labels, such as labels of a figure, a pattern, numerals and fluorescent light, if necessary.

Referring to FIG. 10, it depicts a guide ring for a fishing rod according to the eighth embodiment of the present invention. The guide ring for a fishing rod according to the eighth embodiment is similar to the guide ring for the fishing rod according to the seventh embodiment. The different between the eighth and seventh embodiments is as follows: The fixing frame 12g is formed by two symmetrical conical inclined portions 120g which are downward and slightly outward expanded from two sides of the ring 11g of the guide ring 1g. A longitudinal connection portion 121g is disposed in a space g defined by two symmetrical conical inclined portions 120g. A receiving hole 122g is disposed in the longitudinal connection portion 121g. The receiving hole 122g is provided with different kinds of labels, such as labels of a figure, a pattern, numerals and fluorescent light, if necessary.

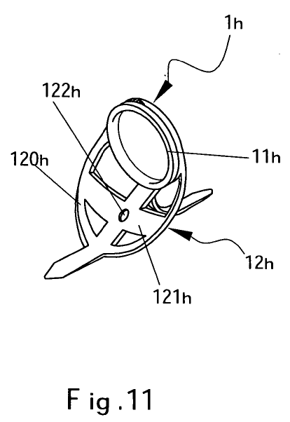

Referring to FIG. 11, it depicts a guide ring for a fishing rod according to the ninth embodiment of the present invention. The guide ring 1h for a fishing rod according to the ninth embodiment is similar to the guide ring 1h for the fishing rod according to the seventh embodiment. The different between the ninth and seventh embodiments is as follows: The fixing frame 12h is formed by two symmetrical conical inclined portions 120h which are downward and slightly outward expanded from two sides of the ring 11h of the guide ring 1h. A longitudinal and transversely connection portion 121h is disposed in a space g defined by two symmetrical conical inclined portions 120h. A receiving hole 122h is disposed in the longitudinal and transversely connection portion 121h. The receiving hole 122h is provided with different kinds of labels, such as labels of a figure, a pattern, numerals and fluorescent light, if necessary.

1. A guide ring for a fishing rod comprising:
a circular ring; and
a fixing frame including:
two symmetrical conical inclined portions being downward expanded from a vicinity of a bottom of the circular ring;
a connection portion disposed between the two symmetrical conical inclined portions; and
a receiving hole disposed in the connection portion and provided with an interchangeable label, the label being inserted directly into the hole.

2. The guide ring for a fishing rod according to claim 1, wherein the interchangeable label is one of a figure, a pattern, numerals and fluorescent light.

3. The guide ring for a fishing rod according to claim 1, wherein the connection portion is a longitudinal connection portion and the receiving hole extends through the connection portion.

4. The guide ring for a fishing rod according to claim 1, wherein the fixing frame further includes at least one space disposed between the two symmetrical conical inclined portions.

5. A guide ring for a fishing rod comprising:
a circular ring;
a first fixing frame including:
two symmetrical conical inclined portions being downward expanded from a vicinity of a bottom of the circular ring of the guide ring;
a connection portion disposed between the two symmetrical conical inclined portions; and
a receiving hole disposed in the connection portion; and
a second fixing frame corresponding to the first fixing frame and extending in an opposite direction.

6. The guide ring for a fishing rod according to claim 5, wherein the connection portion is a longitudinal connection portion and the receiving hole extends through the connection portion.

7. The guide ring for a fishing rod according to claim 5, wherein at least the first fixing frame further includes at least one receiving hole disposed between the two symmetrical conical inclined portions.

8. A guide ring for a fishing rod comprising:
a circular ring; and
a fixing frame including:
two symmetrical conical inclined portions being downward and slightly outward expanded from two sides of the ring of the guide ring;
a connection portion disposed between the two symmetrical conical inclined portions; and
means for directly receiving a label in the connection portion, the means for receiving including a receiving hole disposed in the connection portion.

9. The guide ring for a fishing rod according to claim 8, wherein the connection portion is a longitudinal connection portion and the receiving hole extends through the connection portion.

10. The guide ring for a fishing rod according to claim 8, wherein the connection portion is a longitudinal and transverse connection portion and the receiving hole is in a middle of said connection portion.
